(19) United States
(12) Patent Application Publication
(10) Pub. No.: US 2005/0041619 A1
(43) Pub. Date: Feb. 24, 2005

(54) Wireless systems, methods and devices employing forward- and/or return-link carriers having different numbers of sub-band carriers

(76) Inventors: Peter D. Karabinis, Cary, NC (US); Santanu Dutta, Cary, NC (US)

Correspondence Address: Mitchell S. Bigel;Myers Bigel Sibley & Sajovec, P.A., P.O. Box 37428, Raleigh, NC, 27627, US

(21) Appl. No.: 10/914,515

(22) Filed: Aug. 9, 2004

Related U.S. Application Data
(60) Provisional application No. 60/497,269, filed on Aug. 22, 2003.

(51) Int. Cl. H04L 12/28; H04Q 7/00

(52) U.S. Cl. 370/329; 370/431; 370/478

(57) ABSTRACT

Wireless Orthogonal Frequency Division Multiplexing and/or Orthogonal Frequency Division Multiple Access (OFDM/OFDMA) and/or Time-Frequency Division Multiplexing and/or Time-Frequency Division Multiple Access (T-FDM/T-FDMA) systems and methods include forward and return link carriers comprising numbers of sub-band carrier groupings that are not identical. A return link carrier may consist of fewer sub-band carriers than a forward link carrier and the return link carrier also may consist of a single sub-band carrier.

### CROSS-REFERENCE TO RELATED APPLICATION

This application claims the benefit of provisional Application No. 60/497,269, filed Aug. 22, 2003, entitled Time-Frequency Division Multiplexing (T-FDM) and/or Orthogonal FDM (OFDM) Systems and Methods Employing Unsymmetrical Sub-Band Carrier Groupings, the disclosure of which is hereby incorporated herein by reference in its entirety as if set forth fully herein.

### FIELD OF THE INVENTION

This invention relates to communications systems, methods and devices, and more particularly to wireless communications systems, methods and devices.

### BACKGROUND OF THE INVENTION

Time-Frequency Division Multiplexing and/or Time-Frequency Division Multiple Access (T-FDM/T-FDMA) and Orthogonal Frequency Division Multiplexing and/or Orthogonal Frequency Division Multiple Access (OFDM/OFDMA) systems and methods are widely used for wired and wireless communications. As is well known to those having skill in the art, T-FDM/T-FDMA and OFDM/OFDMA are relatively modern variations of the well known Frequency Division Multiplexing and/or Frequency Division Multiple Access (FDM/FDMA) communications techniques. In general, in FDM/FDMA communications systems and methods, a communications band of frequencies is divided into a number of frequency sub-bands over which sub-band carriers are used to transmit information. In classical wireless FDM/FDMA systems there is a one-to-one relationship between a sub-band carrier and a user (a sub-band carrier is allocated to only one user), and a user device and/or a system device may radiate only one sub-band carrier per carrier. An example of a classical FDM/FDMA system is the analog AMPS cellular communications system that continues to be used in the United States. Another example of a classical FDM/FDMA system is the M-SAT Mobile Satellite System (MSS) that is currently operated by Mobile Satellite Ventures (MSV). Inmarsat also offers MSS services via classical FDM/FDMA techniques.

As used herein, Frequency Division Multiplexing and/or Frequency Division Multiple Access (FDM/FDMA) refers to communications systems, methods, system devices and/or user devices wherein a communications band of frequencies is divided into a number of frequency sub-bands over which a plurality of sub-band carriers may exist, collectively defining a carrier, and where a user's information may be carried by at least one sub-band carrier of the possible plurality of sub-band carriers that may exist over the communications band of frequencies.

In contrast to the classical FDM/FDMA communications systems and methods, wherein a one-to-one correspondence exists between only one sub-band carrier and a user, and a user device and/or a system device may radiate only one sub-band carrier per carrier, in FDM/FDMA communications systems and methods as used herein, and/or OFDM/OFDMA and/or T-FDM/T-FDMA communications systems and methods, a carrier may be defined to comprise more than one sub-band carrier and the information associated with a user may be associated with (transported/carried by) more than one sub-band carrier. In OFDM/OFDMA communications systems and methods, the information that is transported/carried by a sub-band carrier may be conditioned to maintain an orthogonality condition, at a receiver observation time, relative to the information that is carried by any other sub-band carrier belonging to the same and/or different carrier. Thus, relying on time orthogonality, in OFDM/OFDMA systems and methods, the sub-band carriers may be maximally packed in frequency to minimize a frequency separation between adjacent sub-band carriers and/or adjacent carriers. This feature of OFDM/OFDMA systems and methods may maximize spectral efficiency and may not require stringent frequency-domain filtering at a transmitter and/or receiver. In contrast, in non-OFDM/OFDMA systems (such as in FDM/FDMA and/or T-FDM/T-FDMA systems), the ability to separate signals carried by different sub-band carriers and/or different carriers is typically achieved by a frequency selectivity of sub-band and/or carrier filters. The sub-band carriers may be further multiplexed among a plurality of users in time and/or in frequency (Time-Frequency Division Multiplexing and/or Time-Frequency Division Multiple Access), resulting in the general case of combined frequency and time division multiplexing/multiple access (T-FDM/T-FDMA). It will be understood that as used herein OFDM/OFDMA may represent a special case of T-FDM/T-FDMA and/or FDM/FDMA in which a time orthogonality condition may exist between information elements carried by different sub-band carriers of the same and/or different carrier(s). Code Division Multiple Access (CDMA) techniques also may be used to multiplex a plurality to users on one or more sub-band carriers.

OFDM systems and methods are described, for example, in U.S. Pat. Nos. 6,603,734; 6,567,374; 6,377,566; 6,345,036; 6,160,791; 6,021,110; and 5,889,759. OFDM also is described in the tutorial entitled OFDM for Mobile Data Communications, published on the Web by The International Engineering Consortium, available on the Web at iec.org. OFDM is also used for wired communications, for example in Digital Subscriber Line (DSL) technology. Asymmetrical DSL (ADSL) technology is also used to provide DSL service with asymmetric data rates. See, for example, the ADSL Tutorial, published by the DSL Forum, 2001.

### SUMMARY OF THE INVENTION

Embodiments of the present invention provide wireless FDM/FDMA systems, methods and/or devices, such as wireless T-FDM/T-FDMA and/or OFDM/OFDMA systems, methods and/or devices, wherein a sub-band carrier grouping, defining a carrier, is provided in a non-symmetrical manner between a forward and return link thereof. Furthermore, in some embodiments, different forward-link carriers may contain a different number of sub-band carriers, and different return-link carriers may contain a different number of sub-band carriers. As used herein, a forward link is a wireless link that transports user information from a wireless system device to a wireless user device, and a return link is a wireless link that transports user information from the wireless user device to the wireless system device.

Moreover, in some embodiments, a return-link carrier consists of fewer sub-band carriers than a corresponding forward-link carrier. In yet other embodiments, a return-link carrier consists of a single sub-band carrier. Analogous wireless user devices, system devices and methods of operating wireless user devices and wireless system devices also may be provided.

### BRIEF DESCRIPTION OF THE DRAWINGS

FIGS. 1 and 2 are block diagrams of wireless T-FDM/T-FDMA and/or OFDM/OFDMA systems, methods, system devices, user devices and methods of operating same, according to various embodiments of the present invention.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that although the terms first and second are used herein to describe various elements, these elements should not be limited by these terms. These terms are only used to distinguish one element from another element. Thus, a first element below could be termed a second element, and similarly, a second element may be termed a first element without departing from the teachings of the present invention. As used herein, the term “and/or” includes any and all combinations of one or more of the associated listed items. The symbol “/” is also used as a shorthand notation for “and/or”. Moreover, as used herein, the singular forms “a”, “an” and “the” are intended to include the plural forms as well, unless the context clearly indicates otherwise. It will be further understood that the terms “comprises” and/or “comprising,” when used herein, specify the presence of stated features, integers, steps, operations, elements, and/or components, but do not preclude the presence or addition of one or more other features, integers, steps, operations, elements, components, and/or groups thereof. In contrast, the term “consisting of” when used herein, specifies the stated number of sub-band carrier(s) and precludes additional sub-band carrier(s).

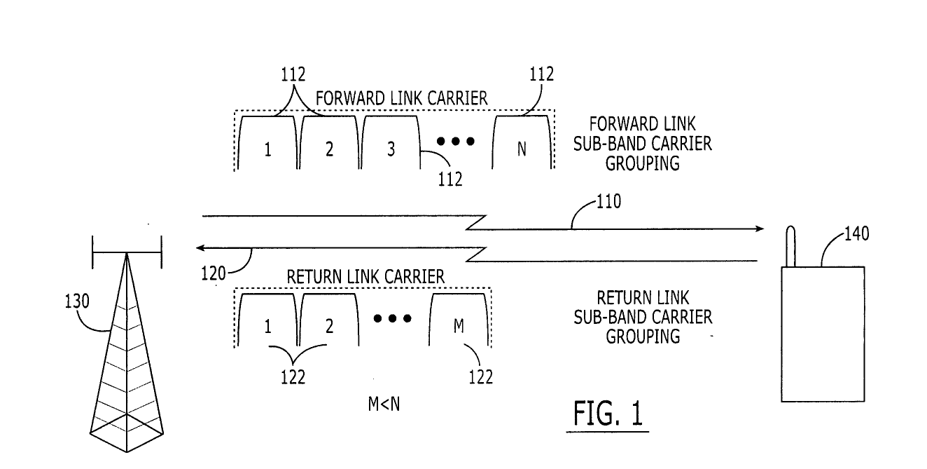

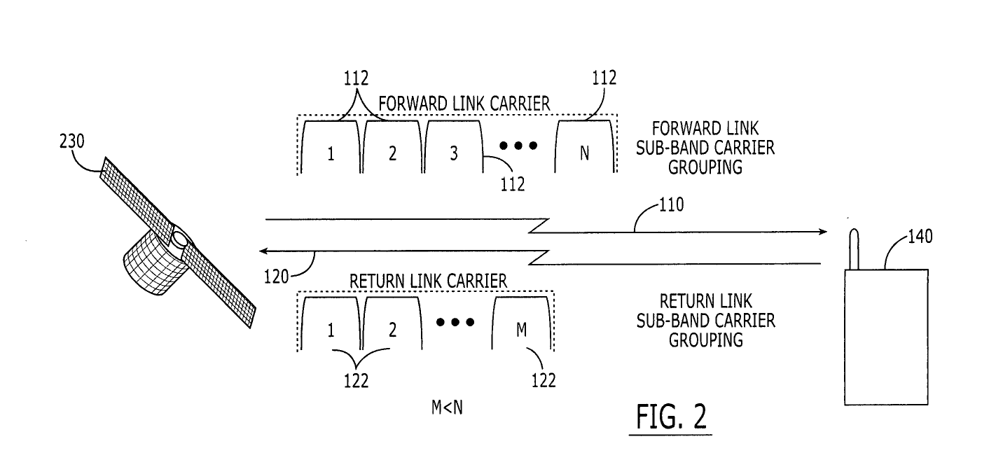

Wireless FDM/FDMA communications systems, methods and/or devices, such as wireless T-FDM/T-FDMA and/or OFDM/OFDMA communications systems, methods and/or devices, according to embodiments of the invention are operative in accordance with a communications protocol comprising non-symmetrically disposed sub-band carrier groupings between the forward and/or return link carriers. As is illustrated in FIGS. 1 and 2, a forward link carrier 110 consists of a grouping of N sub-band carriers 112 while a corresponding return link carrier 120 consists of a grouping of M sub-band carriers 122, where M is less than N (M<N). A forward link carrier consisting of a grouping of N sub-band carriers 112 is used to transmit information from a wireless system device, such as a terrestrial base station 130 (FIG. 1) and/or a satellite 230 (FIG. 2), to a wireless user device 140, while a return link carrier consisting of a grouping of M sub-band carriers 122 is used to transmit information from the wireless user device 140 to the wireless system device 130 and/or 230. It will be understood that the wireless user devices 140 and the wireless system devices 130 and/or 230 may include a transceiver (transmitter/receiver) that is configured to transmit and receive these carriers.

As used herein, the term “wireless user device” 140 includes cellular and/or satellite radiotelephones with or without a multi-line display; Personal Communications System (PCS) terminals that may combine a radiotelephone with data processing, facsimile and/or data communications capabilities; Personal Digital Assistants (PDA) that can include a radio frequency transceiver and a pager, Internet/intranet access, Web browser, organizer, calendar and/or a global positioning system (GPS) receiver; and/or conventional laptop and/or palmtop computers or other appliances, which include a radio frequency transceiver. As used herein, the term “wireless user device” 140 also includes any other radiating user device/equipment/source that may have time-varying or fixed geographic coordinates, and may be portable, transportable, installed in a vehicle (aeronautical, maritime, or land-based), or situated and/or configured to operate locally and/or in a distributed fashion at any other location(s) on earth and/or in space. The terms “radioterminal,” “radiotelephone,” or simply “terminal” may also be used to convey the same meaning as the term wireless user device. Furthermore, as used herein, the term “wireless system device” includes any combination of system equipment (not end-user equipment, such as base station(s) 130 and/or satellite(s) 230) that is (are) configured to radiate electromagnetic energy for the purpose of wirelessly transmitting information to at least one wireless user device.

Moreover, as used herein, a terrestrial base station 130 includes a conventional cellular base station and/or an Ancillary Terrestrial Component (ATC). ATCs are described in U.S. Pat. No. 6,684,057 to Karabinis, entitled Systems and Methods for Terrestrial Reuse of Cellular Satellite Frequency Spectrum; and Published U.S. Patent Application Nos. US 2003/0054760 to Karabinis, entitled Systems and Methods for Terrestrial Reuse of Cellular Satellite Frequency Spectrum; US 2003/0054761 to Karabinis, entitled Spatial Guardbands for Terrestrial Reuse of Satellite Frequencies; US 2003/0054814 to Karabinis et al., entitled Systems and Methods for Monitoring Terrestrially Reused Satellite Frequencies to Reduce Potential Interference; US 2003/0054762 to Karabinis, entitled Multi-Band/Multi-Mode Satellite Radiotelephone Communications Systems and Methods; US 2003/0153267 to Karabinis, entitled Wireless Communications Systems and Methods Using Satellite-Linked Remote Terminal Interface Subsystems; US 2003/0224785 to Karabinis, entitled Systems and Methods for Reducing Satellite Feeder Link Bandwidth/Carriers In Cellular Satellite Systems; US 2002/0041575 to Karabinis et al., entitled Coordinated Satellite-Terrestrial Frequency Reuse; US 2002/0090942 to Karabinis et al., entitled Integrated or Autonomous System and Method of Satellite-Terrestrial Frequency Reuse Using Signal Attenuation and/or Blockage, Dynamic Assignment of Frequencies and/or Hysteresis; US 2003/0068978 to Karabinis et al., entitled Space-Based Network Architectures for Satellite Radiotelephone Systems; US 2003/0143949 to Karabinis, entitled Filters for Combined Radiotelephone/GPS Terminals; US 2003/0153308 to Karabinis, entitled Staggered Sectorization for Terrestrial Reuse of Satellite Frequencies; and US 2003/0054815 to Karabinis, entitled Methods and Systems for Modifying Satellite Antenna Cell Patterns In Response to Terrestrial Reuse of Satellite Frequencies, all of which are assigned to the assignee of the present invention, the disclosures of all of which are hereby incorporated herein by reference in their entirety as if set forth fully herein.

The occupied bandwidth of a sub-band carrier of either a forward link 110 or a return link 120 carrier may be identical, substantially identical, or different from the occupied bandwidth of any other sub-band carrier of the same or other forward and/or return link carrier. A return link sub-band carrier 122 may have a frame structure and may be based on Time Division Multiplexing and/or Time Division Multiple Access (TDM/TDMA), Code Division Multiplexing and/or Code Division Multiple Access (CDM/CDMA), Frequency Division Multiplexing and/or Frequency Division Multiple Access (FDM/FDMA) and/or any other multiplexing/multiple access principle. A forward link sub-band carrier 112 may have a frame structure and may support Time Division Multiplexing and/or Time Division Multiple Access (TDM/TDMA), Code Division Multiplexing and/or Code Division Multiple Access (CDM/CDMA), Frequency Division Multiplexing and/or Frequency Division Multiple Access (FDM/FDMA) and/or any other multiplexing and/or multiple access technique. The sub-band carrier modulation used may be identical, substantially identical, or different between sub-band carriers of the same and/or different forward link 110 and/or the return link 120 carrier(s). A vocoder that may be associated with a sub-band carrier may be identical, substantially identical, or different than a vocoder that may be associated with any other sub-band carrier of the same and/or different forward link 110 and/or the return link 120 carrier(s). Similarly, the Forward Error Correction Coding (FEC) and/or interleaving that may be used to protect information on a sub-band carrier may be identical, substantially identical, or different than the FEC and/or interleaving that may be used to protect information on any other sub-band carrier of the same and/or different forward link 110 and/or the return link 120 carrier(s).

In accordance with some embodiments of the invention, the number of sub-band carriers 122 per return link carrier (sub-band carrier grouping) is made equal to one (M=1) and the entire, or substantially entire, sub-band carrier frame is allocated to one wireless user device 140. This can allow the wireless user device 140 to transmit information to the system continuously or substantially continuously in time, can increase or maximize the E_{b}/N₀ operating point of the wireless receiver, and/or can reduce or minimize the power output of the transmitting device, relative to a return link carrier consisting of a plurality of sub-band carriers and/or where the transmit frame is shared by a plurality of users. An application of these embodiments to wireless communications systems and methods, and in particular to satellite systems and methods, may allow such systems and methods to operate with increased link reliability (link margin) on their return links.

In accordance with some embodiments of the invention, the number of sub-band carriers 122 of a first return link carrier is different than the number of sub-band carriers 122 of a second return link carrier and/or the number of sub-band carriers 112 of a first forward link carrier is different than the number of sub-band carriers 112 of a second forward link carrier. Stated differently, in some embodiments of the invention, N can vary among different forward link carriers of the forward link and/or M can vary among different return link carriers of the return link. This aspect of the invention may be used to maximize or improve spectral utilization and/or spectral efficiency in systems (such as, for example, in L-band systems) where a band of frequencies that is available to the system may comprise a plurality of non-contiguous frequency segments.

In the drawings and specification, there have been disclosed embodiments of the invention and, although specific terms are employed, they are used in a generic and descriptive sense only and not for purposes of limitation, the scope of the invention being set forth in the following claims.

1. A wireless Frequency Division Multiplexing and/or Frequency Division Multiple Access (FDM/FDMA) and/or Orthogonal Frequency Division Multiplexing and/or Orthogonal Frequency Division Multiple Access (OFDM/OFDMA) and/or a Time-Frequency Division Multiplexing and/or Time-Frequency Division Multiple Access (T-FDM/T-FDMA) system including forward and/or return link carriers comprising sub-band carrier groupings that are not identical in number of sub-band carriers.

2. A wireless system according to claim 1 wherein the return link carrier sub-band carrier grouping consists of fewer sub-band carriers than the forward link carrier sub-band carrier grouping.

3. A wireless system according to claim 2 wherein the return link carrier sub-band carrier grouping consists of a single sub-band carrier.

4. A wireless Frequency Division Multiplexing and/or Frequency Division Multiple Access (FDM/FDMA) and/or Orthogonal Frequency Division Multiplexing and/or Orthogonal Frequency Division Multiple Access (OFDM/OFDMA) and/or a Time-Frequency Division Multiplexing and/or Time-Frequency Division Multiple Access (T-FDM/T-FDMA) method comprising wirelessly transporting information over forward and/or return link carriers comprising sub-band carrier groupings that are not identical in number.

5. A wireless method according to claim 4 wherein the return link carrier sub-band carrier grouping consists of fewer sub-band carriers than the forward link carrier sub-band carrier grouping.

6. A wireless method according to claim 5 wherein the return link carrier sub-band carrier grouping consists of a single sub-band carrier.

7. A wireless Frequency Division Multiplexing and/or Frequency Division Multiple Access (FDM/FDMA) and/or Orthogonal Frequency Division Multiplexing and/or Orthogonal Frequency Division Multiple Access (OFDM/OFDMA) and/or a Time-Frequency Division Multiplexing and/or Time-Frequency Division Multiple Access (T-FDM/T-FDMA) system comprising:
a forward link carrier consisting of a forward link sub-band carrier grouping; and
a return link carrier consisting of a return link sub-band carrier grouping that is not identical in number of sub-band carriers to the forward link carrier sub-band carrier grouping.

8. A wireless system according to claim 7 wherein the return link carrier consists of fewer sub-band carriers than the forward link carrier.

9. A wireless system according to claim 8 wherein the return link carrier consists of a single sub-band carrier.

10. A wireless Frequency Division Multiplexing and/or Frequency Division Multiple Access (FDM/FDMA) system device comprising a transceiver that is configured to radiate a forward link carrier that transports information to at least one wireless user device over a sub-band carrier grouping comprising a number of sub-band carriers and is also configured to receive a return link carrier that transports information from at least one wireless user device to the system device over a sub-band carrier grouping comprising a number of sub-band carriers that is not identical to the number of sub-band carriers of the forward link carrier sub-band carrier grouping.

11. A wireless system device according to claim 10 wherein the return link carrier sub-band carrier grouping consists of fewer sub-band carriers than the forward link carrier sub-band carrier grouping.

12. A wireless system device according to claim 11 wherein the return link carrier sub-band carrier grouping consists of a single sub-band carrier.

13. A wireless system device according to claim 10 wherein the wireless FDM/FDMA system device comprises a wireless Orthogonal Frequency Division Multiplexing and/or Orthogonal Frequency Division Multiple Access (OFDM/OFDMA) and/or a Time-Frequency Division Multiplexing and/or Time-Frequency Division Multiple Access (T-FDM/T-FDMA) system device.

14. A wireless Frequency Division Multiplexing and/or Frequency Division Multiple Access (FDM/FDMA) user device comprising a transceiver that is configured to receive a forward link carrier that transports information from at least one wireless system device to the wireless user device over a sub-band carrier grouping comprising a number of sub-band carriers and is also configured to transmit a return link carrier that transports information from at least one wireless user device to the at least one system device over a sub-band carrier grouping comprising a number of sub-band carriers that is not identical to the number of sub-band carriers of the forward link carrier sub-band carrier grouping.

15. A wireless user device according to claim 14 wherein the return link carrier sub-band carrier grouping consists of fewer sub-band carriers than the forward link carrier sub-band carrier grouping.

16. A wireless user device according to claim 15 wherein the return link carrier sub-band carrier grouping consists of a single sub-band carrier.

17. A wireless user device according to claim 14 wherein the FDM/FDMA wireless user device comprises a wireless Orthogonal Frequency Division Multiplexing and/or Orthogonal Frequency Division Multiple Access (OFDM/OFDMA) and/or a Time-Frequency Division Multiplexing and/or Time-Frequency Division Multiple Access (T-FDM/T-FDMA) user device.

18. A method of operating a wireless Frequency Division Multiplexing and/or Frequency Division Multiple Access (FDM/FDMA) system device comprising:
wirelessly transporting user information from the wireless system device to at least one wireless user device over a forward link carrier consisting of a sub-band carrier grouping; and
wirelessly transporting user information to the wireless system device from at least one wireless user device over a return link carrier consisting of a sub-band carrier grouping that is not identical in number of sub-band carriers to the forward link carrier sub-band carrier grouping.

19. A method according to claim 18 wherein the return link carrier sub-band carrier grouping consists of fewer sub-band carriers than the forward link carrier sub-band carrier grouping.

20. A method according to claim 19 wherein the return link carrier sub-band carrier grouping consists of a single sub-band carrier.

21. A method according to claim 18 wherein the wireless FDM/FDMA system device comprises a wireless Orthogonal Frequency Division Multiplexing and/or Orthogonal Frequency Division Multiple Access (OFDM/OFDMA) and/or a Time-Frequency Division Multiplexing and/or Time-Frequency Division Multiple Access (T-FDM/T-FDMA) system device.

22. A method of operating a wireless Frequency Division Multiplexing and/or Frequency Division Multiple Access (FDM/FDMA) user device comprising:
wirelessly transporting user information to the wireless user device from at least one wireless system device over a forward link carrier consisting of a sub-band carrier grouping; and
wirelessly transporting user information from the wireless user device to at least one wireless system device over a return link carrier consisting of a sub-band carrier grouping that is not identical in number of sub-band carriers to the forward link sub-band carrier grouping.

23. A method according to claim 22 wherein the return link carrier sub-band carrier grouping consists of fewer sub-band carriers than the forward link carrier sub-band carrier grouping.

24. A method according to claim 23 wherein the return link carrier sub-band carrier grouping consists of a single sub-band carrier.

25. A method according to claim 22 wherein the wireless FDM/FDMA user device comprises a wireless Orthogonal Frequency Division Multiplexing and/or Orthogonal Frequency Division Multiple Access (OFDM/OFDMA) and/or a Time-Frequency Division Multiplexing and/or Time-Frequency Division Multiple Access (T-FDM/T-FDMA) user device.

26. A wireless Frequency Division Multiplexing and/or Frequency Division Multiple Access (FDM/FDMA) and/or Orthogonal Frequency Division Multiplexing and/or Orthogonal Frequency Division Multiple Access (OFDM/OFDMA) and/or a Time-Frequency Division Multiplexing and/or Time-Frequency Division Multiple Access (T-FDM/T-FDMA) system comprising wireless user devices and wireless system devices that communicate using a plurality of forward- and/or return-link carriers comprising sub-band carrier groupings that differ in number of sub-band carriers.

27. A wireless system according to claim 26 wherein a first return link carrier sub-band carrier grouping consists of fewer sub-band carriers than a second return link carrier sub-band carrier grouping.

28. A wireless system according to claim 26 wherein a first forward link carrier sub-band carrier grouping consists of fewer sub-band carriers than a second forward link carrier sub-band carrier grouping.

29. A wireless system according to claim 26 wherein a wireless system device is configured to receive a first and/or a second return link carrier sub-band carrier grouping where the first return link carrier sub-band carrier grouping consists of fewer sub-band carriers than the second return link carrier sub-band carrier grouping.

30. A wireless system according to claim 29 wherein a wireless system device is configured to transmit a first and/or a second forward link carrier sub-band carrier grouping where the first forward link carrier sub-band carrier grouping consists of fewer sub-band carriers than the second forward link carrier sub-band carrier grouping.

31. A wireless system according to claim 26 wherein a wireless user device is configured to receive a first and/or a second forward link carrier sub-band carrier grouping where the first forward link carrier sub-band carrier grouping consists of fewer sub-band carriers than the second forward link carrier sub-band carrier grouping.

32. A wireless system according to claim 31 wherein the wireless user device is configured to transmit a first and/or a second return link carrier sub-band carrier grouping where the first return link carrier sub-band carrier grouping consists of fewer sub-band carriers than the second return link carrier sub-band carrier grouping.

33. A wireless Frequency Division Multiplexing and/or Frequency Division Multiple Access (FDM/FDMA) and/or wireless Orthogonal Frequency Division Multiplexing and/or Orthogonal Frequency Division Multiple Access (OFDM/OFDMA) and/or a Time-Frequency Division Multiplexing and/or Time-Frequency Division Multiple Access (T-FDM/T-FDMA) method comprising wirelessly transporting information over a plurality of forward- and/or return-link carriers comprising sub-band carrier groupings that differ in number of sub-band carriers.

34. A wireless method according to claim 33 wherein a first return link carrier sub-band carrier grouping consists of fewer sub-band carriers than a second return link carrier sub-band carrier grouping.

35. A wireless method according to claim 33 wherein a first forward link carrier sub-band carrier grouping consists of fewer sub-band carriers than a second forward link carrier sub-band carrier grouping.
